(19) United States
(12) Patent Application Publication
(10) Pub. No.: US 2004/0094028 A1
(43) Pub. Date: May 20, 2004

(54) Hydraulic dampening system

(76) Inventors: Ian Sheard, Upland, CA (US); Peter A. Rosa, Madison, CT (US)

Correspondence Address: Barry L. Kelmachter, BACHMAN & LaPOINTE, P.C., 900 Chapel Street, Suite 1201, New Haven, CT, 06510-2802, US

(21) Appl. No.: 10/299,884

(22) Filed: Nov. 19, 2002

(51) Int. Cl. F15B 13/10

(52) U.S. Cl. 91/394

(57) ABSTRACT

The present invention relates to a hydraulic dampening system which has particular utility with power tools. The hydraulic dampening system includes a cylinder and a piston positioned within and movable through a stroke. The piston has a retract face which forms a first chamber with a first end wall of the cylinder and a face opposed to the retract face which forms a second chamber with a second end wall of the cylinder. The hydraulic dampening system also includes at least one port and/or at least one gap for dampening movement of the piston during its stroke.

### BACKGROUND OF THE INVENTION

The present invention relates to a hydraulic dampening system which has particular utility with fluid operated tools.

With the employment of hydraulics to generate forces to perform work, over-travel can occur that potentially causes damage to the tool, thus limiting tool longevity. In the case of hydraulic torque wrenches, the piston being driven by oil pressure will translate the forces from the oil build up of pressure against the ratchet via the drive pawl, thus creating high torque levels needed to break nuts free. When the holding torque is overcome, the nut breaks free. This allows the piston, which is still being driven by high oil pressure, to lunge forward. Due to internal space limitations, the piston will then collide with an inside surface of the tool, e.g. shroud or housing, thus potentially causing damage to the piston head and/or the housing or shroud.

U.S. Pat. No. 6,311,585 to Jamra et al. illustrates one flow regulation device to be used with fluid operated tools. This system while effective is expensive to manufacture.

Thus, a simpler, less expensive system for dampening the movement of a piston is still desired.

### SUMMARY OF THE INVENTION

It is an object of the present invention to provide a system for dampening the motion of a piston during its stroke.

It is a further object of the present invention to provide a dampening system as above which has particular utility in a fluid operated tool.

The foregoing object is attained by the hydraulic dampening system of the present invention.

In accordance with the present invention, a hydraulic dampening system is provided which broadly comprises a cylinder and a piston positioned within the cylinder and movable through a stroke. The piston has a retract face which forms a first chamber with a first end wall of the cylinder and a face opposed to the retract face and forming a second chamber with a second end wall of the cylinder. The hydraulic dampening system further comprises means for dampening movement of the piston during the stroke. The dampening movement means may comprise one or more dampening ports and one or more gaps between the piston and the cylinder.

The present invention also relates to a power tool having a hydraulic dampening system in accordance with the present invention. The power tool broadly comprises a cylinder, a piston for actuating a mechanism, and means for dampening movement of the piston during a stroke. The piston is positioned within the cylinder and is movable through a stroke.

Other details of the hydraulic dampening system of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a hydraulic dampening system of the present invention.

FIG. 2 is a schematic representation of the hydraulic dampening system of FIG. 1 in a backpressure build up state;

FIG. 3 is a schematic representation of the hydraulic dampening system of FIG. 1 illustrating the piston at the beginning of a stroke;

FIG. 4 is a schematic representation of an alternative embodiment of a hydraulic dampening system in accordance with the present invention;

FIG. 5 is a schematic representation of another alternative embodiment of a hydraulic dampening system in accordance with the present invention;

FIG. 6 illustrates a power tool having the hydraulic dampening system of the present invention with the piston in a retracted position; and

FIG. 7 illustrates the power tool of FIG. 6 with the piston in an actuation position.

### DETAILED DESCRIPTION OF THE PREFERRED EMBODIMENT(S)

Referring now to the drawings, FIG. 1 illustrates a hydraulic dampening system 10 in accordance with the present invention. The system 10 includes a cylinder 12 and a piston 14 movable within the cylinder 12. The piston 14 has a retract face 16 which forms a first chamber 18 with a first end wall 20 of the cylinder 12. The piston 14 also has a face 21 opposed to the retract face 16. The face 21 forms a second chamber 22 with a second end wall 24 of the cylinder 12. Two fluid ports 26 and 28 are provided in the cylinder 12.

In a preferred embodiment of the present invention, at least one gap 30 is provided between the piston 14 and at least one side wall 32 of the cylinder 12. If the piston 14 is polygonal in cross section, the number of gaps 30 may be equal to the number of piston sides and the number of cylinder side walls.

In the embodiment shown in FIG. 1, the port 26 is an inlet port connected to an actuate line (not shown) and the port 28 is an outlet port connected to a retract line (not shown). As fluid enters the second chamber 22 via the port 26 and pressure increases in the chamber 22, the piston 14 starts to move and there is no restriction of the fluid flowing through the ports 26 and 28.

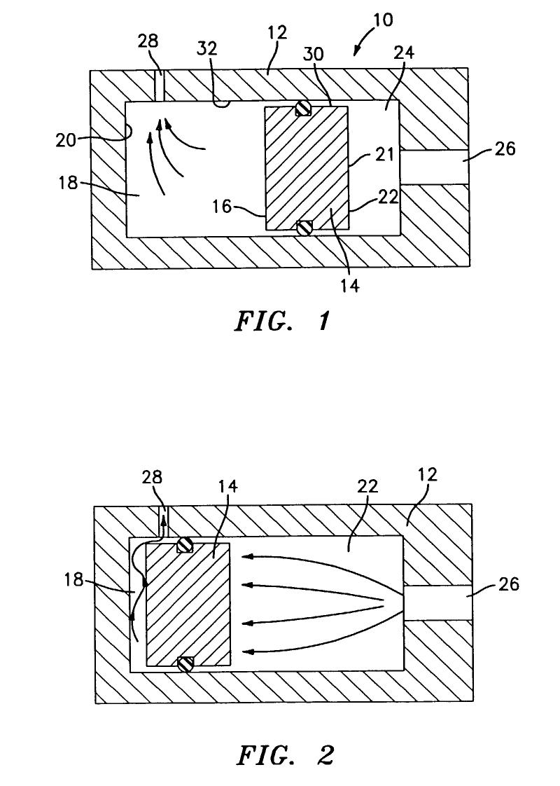

Referring now to FIG. 2, the piston 14 starts to cover the port 28 and thus restricts the amount of fluid flowing through the port 28, since the retract fluid flow is now restricted by the gap 30. This causes a build-up of pressure in the first chamber 18, thus causing a dampening effect slowing down the motion of the piston 14. The faster the movement of the piston 14, the greater the backpressure, and the more significant the dampening effect which is created.

The amount of dampening which is obtained using the system 10 may be controlled by the size of the ports 26 and 28 and by the size of the gap(s) 30. The gap(s) 30 are typically in the range of from 0.0015″ to 0.004″. The gap dimension tends to be regulated by the dimensions used for O-ring tolerances for cylinder/bore applications. The smaller each gap 30, the more pronounced the dampening effect. The diameter of the retract port should be large enough to allow the desired speed during normal operation, preferably as large as the diameter of the actuate port. If the diameter of the retract port is too small, then it will dampen the piston throughout the stroke, and not just the end, causing the cycle time to be long.

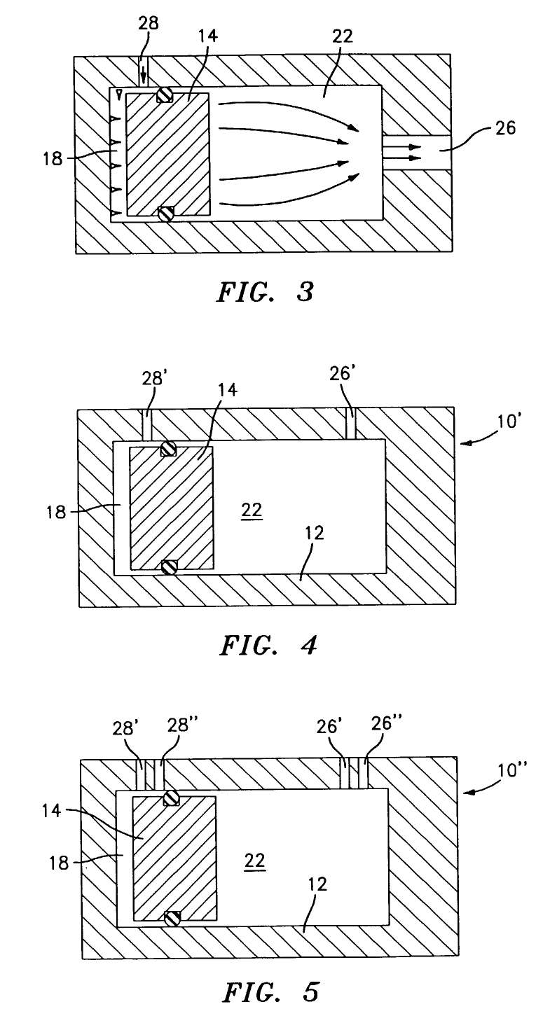

Referring now to FIG. 3, port 28 becomes an inlet port connected to a retract line (not shown) through which fluid enters the first chamber 18. As fluid flow and pressure are applied to port 28, it is restricted from entering the chamber 18 due to the piston 14 covering the port 28. As a result, the piston 14 will start to move slowly at the beginning of its stroke. As the piston 14 moves past the port 28, the restriction on the fluid entering the chamber 18 decreases until the flow is unrestricted and the piston 14 reaches maximum velocity.

FIG. 4 illustrates a dampening system 10′ which has dampening ports 26′ and 28′ on both the inlet and the outlet. This allows for dampening at the beginning of a cycle, thus allowing smooth transition of force to mechanical linkages when high pressure is quickly applied, and at the end.

FIG. 5 illustrates a dampening system 10″ that has multiple dampening ports 26′, 26″, 28′ and 28″ on both the inlet and the outlet. This allows a multi-stage dampening effect.

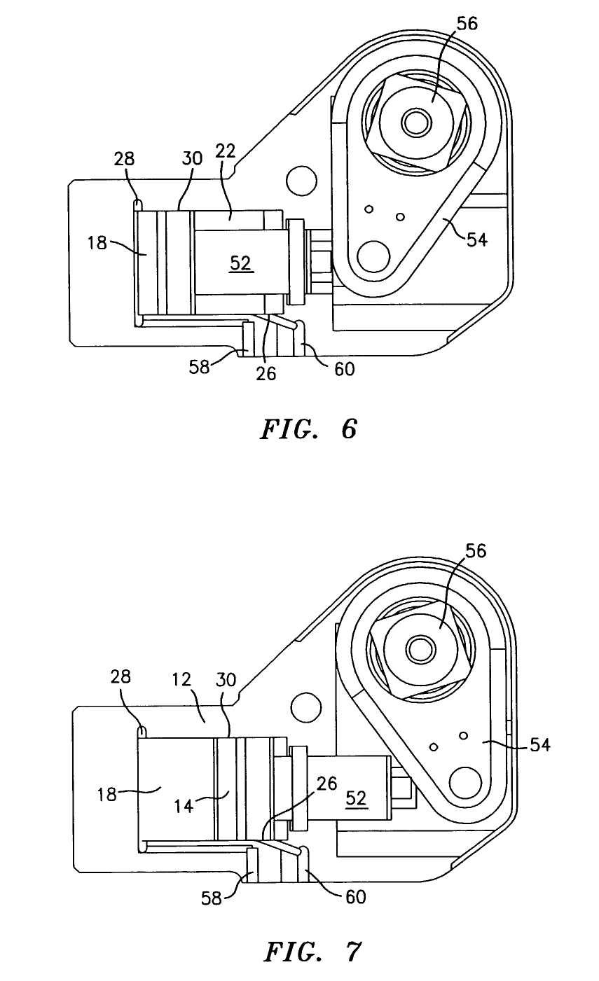

FIGS. 6 and 7 illustrate a power tool 50 such as that shown in U.S. Pat. No. 6,311,585, which is hereby incorporated by reference. As shown in these figures, the tool 50 has a cylinder 12 and a piston 14 movable in the cylinder. The piston 14 forms a first chamber 18 with an end wall of the cylinder 12 and a second chamber 22 with an opposed end wall of the cylinder 12. At least one gap 30 exists between the piston 14 and a sidewall of the cylinder 12.

A piston rod 52 is attached to one face of the piston 14. The piston rod 52 is in turn attached to two drive plates 54 which are used to drive a ratchet and pawl mechanism (not shown) for generating a torque by way of an appropriate socket 56.

As shown in FIGS. 6 and 7, the hydraulic dampening system of the present invention may be incorporated into the tool 50. As shown in the Figures, ports 28 and 26 may be provided in the cylinder 12. The ports 28 and 26 may communicate with passageways 58 and 60 which in turn communicate with a source of hydraulic fluid (not shown). The dampening system would work as described hereinabove to prevent overstroking of the piston 14.

In operation, the piston 14 partially covers the port 26 as it moves towards its actuated position (FIG. 7). The piston 14 restricts a flow of fluid out of the port 26 causing an increase in pressure (backpressure) in the chamber 22, resulting in a slowing motion of the piston 14. The piston 14 thus restricts fluid from also entering the cylinder through the port 26. When the piston 14 begins to move as a result of a pressure build-up in the second chamber 22, the retract port 26 (now the inlet) is uncovered. The piston 14 then begins its retract stroke and continues the stroke at a desired speed.

It is apparent that there has been provided in accordance with the present invention a hydraulic dampening system which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A hydraulic dampening system comprising:
a cylinder;
a piston positioned within said cylinder and movable through a stroke;
said piston having a retract face and forming a first chamber between said retract face and a first end wall of said cylinder;
said piston further having a face opposed to said retract face and forming a second chamber between said opposed face and a second end wall of said cylinder; and
means for dampening movement of said piston during said stroke.

2. The hydraulic dampening system of claim 1, wherein said dampening means comprises a port in fluid communication with said first chamber and said port being sized to be at least partially covered by said piston during said stroke.

3. The hydraulic dampening system of claim 2, wherein said port comprises an outlet port and said piston restricts a flow of fluid out of said outlet port causing an increase in pressure in said first chamber, and slowing motion of the piston.

4. The hydraulic dampening system of claim 2, further comprising providing at least one gap between said piston and at least one side wall of said cylinder to control the amount of dampening.

5. The hydraulic dampening system of claim 2, wherein said port comprises an inlet port and said piston covers said inlet port and restricts fluid from entering said cylinder through said inlet port and wherein said piston begins to move and uncover said inlet port as a result of a pressure build-up in said first chamber.

6. The hydraulic dampening system of claim 1, wherein said dampening means comprises at least one port communicating with each of said first and second chambers.

7. The hydraulic dampening system of claim 6, wherein said dampening means comprises at least two ports communicating with each of said first and second chambers.

8. A power tool comprising:
a cylinder;
a piston for actuating a mechanism;
said piston being positioned within the cylinder and movable through a stroke; and
means for dampening movement of said piston during said stroke.

9. A power tool according to claim 8, wherein said dampening means comprises a port in fluid communication with a first chamber and said port being sized to be at least partially covered by said piston during said stroke.

10. A power tool according to claim 9, wherein said port comprises an outlet port and said piston restricts a flow of fluid out of said outlet port causing an increase in pressure in the first chamber, and slowing motion of the piston.

11. A power tool according to claim 9, further comprising at least one gap between said piston and at least one side wall of said cylinder to control the amount of dampening.

12. A power tool according to claim 9, wherein said port comprises an inlet port and said piston covers said inlet port and restricts fluid from entering said cylinder through said inlet port and wherein said piston begins to move and uncover said inlet port as a result of a pressure build-up in said first chamber.
